(19) United States
(12) Patent Application Publication
(10) Pub. No.: US 2023/0358416 A1
(43) Pub. Date: Nov. 9, 2023

(54) Personalized Heating System

(71) Applicant: Beam Tech, Inc., Pittsburgh, PA (US)

(72) Inventor: Rohan Sanjay Pandya, Oakland, CA (US)

(21) Appl. No.: 18/312,211

(22) Filed: May 4, 2023

Related U.S. Application Data
(60) Provisional application No. 63/364,215, filed on May 5, 2022.

(51) Int. Cl. F24D 19/10; G21K 1/02

(52) U.S. Cl. CPC F24D 19/1096; G21K 1/02

(57) ABSTRACT

A personalized heating system is disclosed. The system includes: a heat source; one or more actuators configured to set a direction of heat emitted by the heat source; one or more sensors that capture sensor data about an environment; a processor; and programming instructions that are configured to, when executed, cause the processor to perform various functions. The functions include processing the sensor data and identifying a target person in the environment, along with a first target area for the target person. The system will cause the one or more actuators to set the direction of heat emitted by the heat source toward the first target area. The system will then cause the heat source to generate heat and directing heat as a heat beam toward the first target area.

### RELATED APPLICATION AND CLAIM OF PRIORITY

This patent document claims priority to U.S. provisional patent application No. 63/364,215, filed May 5, 2023. The disclosure of the priority application is fully incorporated into this document by reference.

### BACKGROUND

Current systems for heating a person are often inefficient, especially when the environment in which the person is located is large and/or outdoors. If the person is located in a large indoor space, the entire space must be heated to provide a comfortable ambient temperature for the person, even if the person occupies only a tiny fraction of the space. If the person is located outdoors, the person must be located very close to the heater, and dissipation of the heat into the environment means that the heater must continually operate at a high level.

To address these issues, space heaters have been developed. However, most space heaters must use a significant amount of energy to warm the space where a person is located, and much energy is wasted as the heat dissipates to areas where no people are present. In addition, when the person moves away from the area that the space heater conditions, the person will not be comfortable unless an additional space heater is available to heat the person's new location.

This document describes methods and systems that are directed to resolving at least some of the issues described above.

### SUMMARY

In a first aspect, a personalized heating system is disclosed. The system includes: a heat source; one or more actuators configured to set a direction of heat emitted by the heat source; one or more sensors that capture sensor data about an environment; a processor; and programming instructions that are configured to, when executed, cause the processor to perform various functions. The functions include processing the sensor data and identifying a target person in the environment, along with a first target area for the target person. The system will cause the one or more actuators to set the direction of heat emitted by the heat source toward the first target area. The system will then cause the heat source to generate a beam of heat and directing the beam of heat toward the first target area.

In some embodiments, the system may process the sensor data and determine that the target person is moving or has moved in the environment. In response to determining that the target person is moving or has moved, the system may identify a second target area. The system may then cause the one or more actuators to move the heat source to direct the beam of heat toward the second target area.

In any of the embodiments described above, the system may access, from a data store, a profile for the target person. The system may use the preference data in the profile to determine an intensity level. Then, when causing the heat source to generate the beam of heat, the heat source may generate the beam of heat at the determined intensity level.

In any of the embodiments described above, the system may access, from a data store, a profile for the target person. The system may use the profile to determine, from a pattern of movement in the profile, an anticipated time at which the target person is expected to move to a second target area. Then, at or within a threshold time period before the anticipated time, the system may cause the one or more actuators to move the heat source to direct the beam of heat toward the second target area.

In any of the embodiments described above, the heat source may be housed within or on top of an emitter base. The emitter base may comprise a plurality of grooves. One or more filaments comprising ductile material may be wound around the emitter base within the grooves.

In any of the embodiments described above, the system may include a collimator, and the heat source may be housed within an emitter base that is positioned to emit heat toward the collimator. The collimator may be configured to focus the heat into the beam of heat. In some of the embodiments, the collimator may comprise a parabolic reflector, and the emitter base may be positioned to emit heat toward a concave surface of the parabolic reflector. In some of the embodiments, the system may include a lens positioned to receive and focus heat reflected off of the concave surface of the parabolic reflector.

In any of the embodiments described above, the heat source may be housed within an emitter base, and the emitter base may comprise a surface having plurality of surface features that increase the effective surface area of the surface relative to a smooth surface.

In a second aspect, a heating system includes: (a) a heat source; (b) one or more actuators configured to set a direction of heat emitted by the heat source; (c) one or more sensors that capture sensor data about an environment; (d) a collimator; (e) an emitter base that houses the heat source and that is positioned to emit heat generated by the heat source toward the collimator so that the collimator will focus the heat into a beam of heat; (f) a processor; and (g) programming instructions that are configured to, when executed, cause the processor to (i) process the sensor data and identify a target person in the environment and a first target area for the target person, (ii) cause the one or more actuators to set the direction of the beam of heat toward the first target area, and (iii) cause the heat source to generate the beam of heat, thereby directing the heat toward the first target area.

In some embodiments of the second aspect, the collimator comprises a parabolic reflector, and the emitter base is positioned to emit heat toward a concave surface of the parabolic reflector. Optionally, the system may include a lens positioned to receive and focus heat reflected off of the concave surface of the parabolic reflector.

In any of the embodiments of the second aspect described above, the emitter base may comprise a surface having plurality of surface features that increase the effective surface area of the surface relative to a smooth surface.

In a third aspect, a method of providing personalized heating to a target is disclosed. The method includes, by a processor, receiving sensor data from one or more sensors; processing the sensor data to identify a target person in the environment and a first target area for the target person. The method also includes causing one or more actuators to set a direction of heat emitted by a moveable heat source toward the first target area. The method then includes causing the heat source to generate heat, collimate the heat into a beam of heat, and directing the beam of heat toward the first target area.

Optionally, the third aspect also may include processing the sensor data and determining whether the target person is moving or has moved in the environment. If so, then in response to determining that the target person is moving or has moved, the method may include identifying a second target area, and also causing the one or more actuators to move the heat source to direct the beam of heat toward the second target area.

Optionally, any of the above embodiments of the third aspect also may include accessing, from a data store, a profile for the target person. The method may then include using preference data in the profile to determine an intensity level. Then, when causing the heat source to generate the beam of heat, the method may include causing the heat source to generate the beam of heat at the determined intensity level.

Optionally, any of the above embodiments of the third aspect also may include: accessing, from a data store, a profile for the target person; using the profile to determine, from a pattern of movement in the profile, an anticipated time at which the target person is expected to move to a second target area; and at or within a threshold time period before the anticipated time, causing the one or more actuators to move the heat source to direct the beam of heat toward the second target area.

Optionally, in any of the above embodiments of the third aspect, in response to identifying multiple potential targets, the method may include: (i) using a target prioritization system to rank the potential targets, and (ii) selecting, as the target, the potential target having the highest rank.

Optionally, in any of the above embodiments of the third aspect, in response to identifying multiple potential targets, the method may include: (i) using a target prioritization system to classify the potential targets, and selecting, as the target, the potential target having a specified class.

### BRIEF DESCRIPTION OF THE DRAWINGS

FIG. 1 illustrates an example environment in which a heating system is installed for the targeted delivery of heat to a person.

FIG. 2 illustrates example subsystems of a heating system according to various embodiments.

FIG. 3 illustrates example elements of a heating unit.

FIG. 4 is a flow diagram illustrating a method of operating a personalized heating system.

FIG. 5 illustrates example elements of a computing system.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

In this document, the term “connected”, when referring to two physical structures, means that the two physical structures touch each other. Devices that are connected may be secured to each other, or they may simply touch each other and not be secured.

In this document, the term “electrically connected”, when referring to two electrical components, means that a conductive path exists between the two components. The path may be a direct path, or an indirect path through one or more intermediary components.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

Additional terms that are relevant to this disclosure will be defined at the end of this Detailed Description section.

This document describes a system that delivers customized, targeted heat to one or more specific locations, individuals, or goods with high efficiency. As a result, the system also reduces unnecessary heat delivery to the surroundings or ambient environment that is not the intended target of the heat. The system identifies and discriminates the target location from the surroundings, generates radiant heat, and focuses and directs a beam of the generated heat towards the target. Efficient heat delivery leads to reduced energy usage and cost savings, and systems with multiple heating units may heat more people or objects with less energy and at a lower total cost than prior systems.

Optionally, the system also may customize the heat based on the target's needs. Customization of the heat enables people and objects to be heated to levels that are tailored to their needs, thus increasing comfort in, and reducing user dissatisfaction with, an environment.

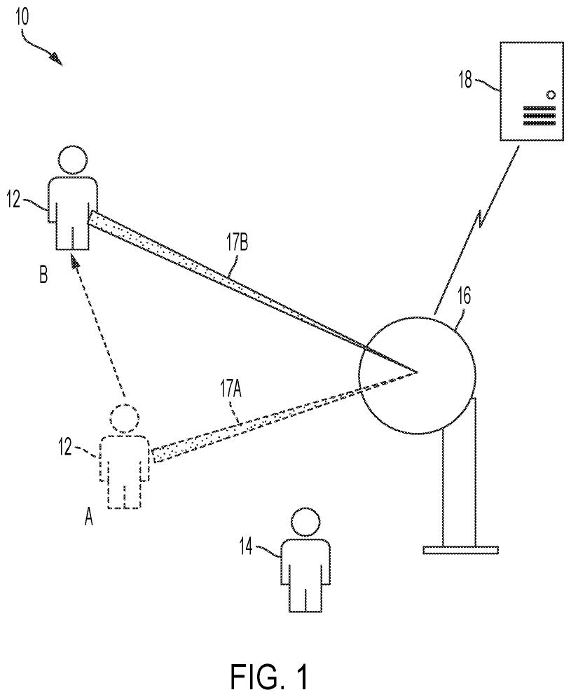

FIG. 1 illustrates an example environment 10 in which a heating unit 16 is installed for the targeted delivery of heat to a person 12. When the person 12 is positioned at a first location A, the heating unit 16 generates and directs a beam of heat 17A toward the person 12 at location A. When the person moves to location B in the environment 10, the heating unit 16 continues to generate heat but now directs the beam of heat 17B toward the person 12 at location B. Methods and systems that enable heating unit 16 to do this will be described below. The heating unit 16 can distinguish the target person 12 from other people 14 and objects in the environment so that it focuses the heat on the target person and not on other locations. Optionally, the heating unit 16 may include one or more subsystems that communicate with a remote server 18 that provides commands for operation, data such as personal profile data, or other messages or data that are used in operation of the system.

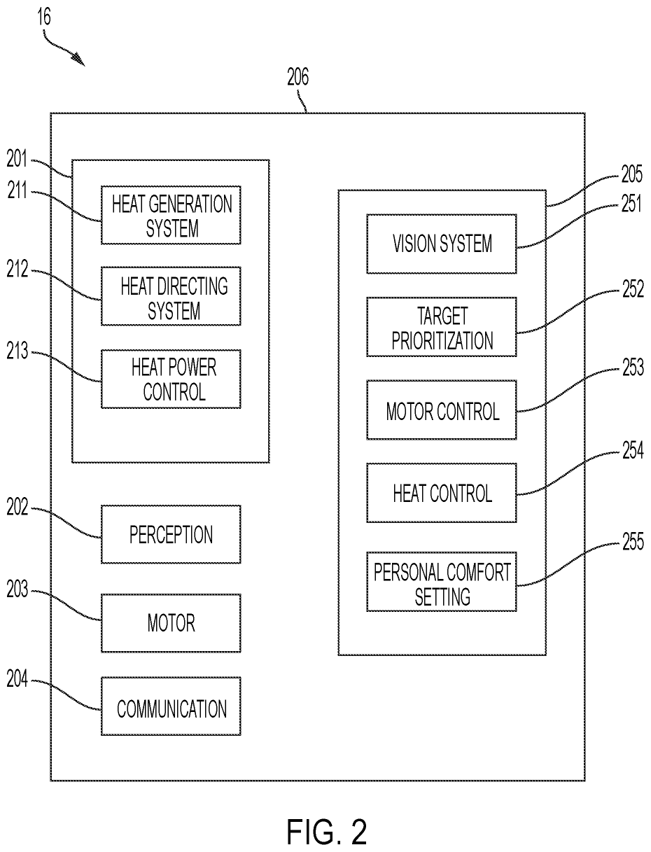

FIG. 2 illustrates example subsystems of a heating unit 16 such as that depicted in FIG. 1. The heating unit is a system that includes a heating subsystem 201, a perception subsystem 202, an actuator such as a motor 203 or other system that enables the heating unit 16 to move, a communication portal 204 such as an antenna or a wired communication port, a computing system 205, and an enclosure 206, Optionally, the heating unit 16 may be part of a system that includes a remote server (such as server 18 shown in FIG. 1). Each system includes hardware, computing devices with a memory and software, or both, that are configured to perform various functions which will now be described.

The heating subsystem 201 will include a heat generation subsystem 211 that is a heat source configured to generate and emit radiant heat and thus condition the temperature of air around a target. In some embodiments, the configuration of the heat generation system 211 will maximize (or at least generate significantly more) electromagnetic emissions in a spectrum that is safely and readily absorbed by human tissue, and it will minimize (or at least significantly reduce) electromagnetic emissions in the visible light spectrum. The heat generation subsystem 211 also may be designed to reduce the emitter's size while increasing the emitter's collimation potential.

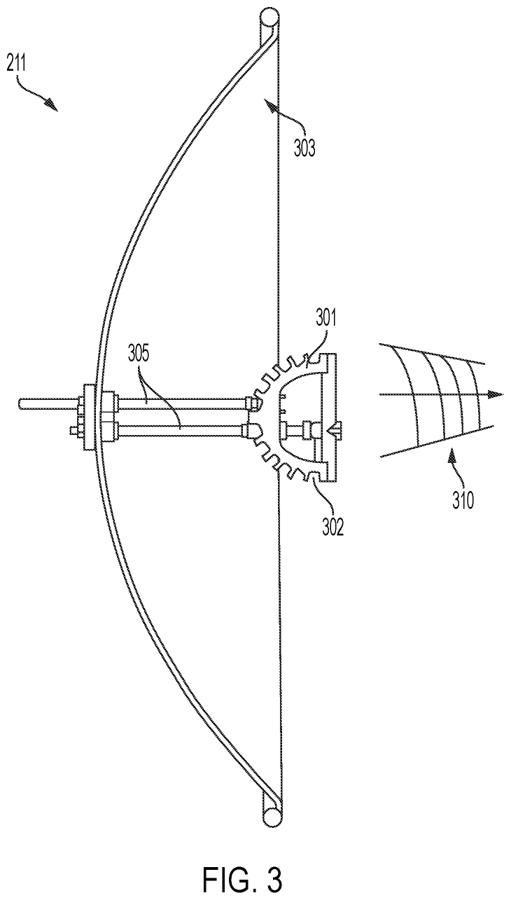

FIG. 3 illustrates example components of the heat generation subsystem 211, including an emitter base 301 that serves as a support structure for the heat source. The base also absorbs heat via conduction, convection and radiation from the heat source and re-radiates the heat. Materials such as ceramic can enable such temperature-controlling features. The radiant heat output from the base 301 may be dependent on the surface area, temperature and emissivity of the emitter base as dictated by the Stefan Boltzmann law:

P=eσAT²

in which P=the power radiated (watts), e=emissivity, σ=the Stefan-Boltzmann constant (5.67×10⁻⁸ kg W m⁻² K⁻⁴), A=surface area (m²) and T=temperature (Kelvin).

The surface area A of the emitter base 301 can be increased by using surface features including geometries that increase or maximize the view factor between the emitter base 301 and a reflector 303, where maximizing the surface area is insufficient. Examples of such geometries include those corresponding to dimples on a golf ball, spikes on a morning star, or teeth on a gear. Such geometries rise up from and/or extend into the surface's primary plane, thus increasing the total surface as compared to a structure in which the surface were smooth along the primary plane.

For emitter geometries such as those described above, the temperature T of the surface of the emitter base 301 can be increased by increasing the intensity of the energy source (see the description of heat power control system 313 below) or reducing the losses via convection and conduction. Convective losses can be reduced by putting the heating subsystem in an enclosed environment or a vacuum. Conductive losses can be reduced by reducing the size of the support material.

The emissivity e of the emitter base 301 is a property inherent to the material of which the base is made. The emissivity of the emitter base 301 can be improved by applying a high emissivity coating (such as high emissivity black paint or a black anodized coating) to the base. The spectral emissivity of the coating can be used to achieve the required spectral characteristics of the emitted radiation.

The heat source 302 within the emitter base 301 may use any conventional or custom sources such as an electric heating unit (e.g., resistive or heat pump), a carbon fuel-based (oil, propane, natural gas, etc.) heater such as a gas-fired infrared tube heater, or other devices. An electric resistive heating unit (which is the example heat source 302 shown in FIG. 3) would generate heat through one or more filaments that are wound around emitter base 301. The filament(s) may be formed of ductile materials, preferably ones that have that have high resistivity, high melting point, and high corrosion resistance against oxidation at high temperatures. Resilience against repeated high temperature cycling can also be a helpful feature of the filament material. Some materials that fit some or all of these requirements include: nickel based alloys such as Nichrome, Kanthal and Constantan; stainless steel alloys; carbon allotropes such as graphite or graphene; and tungsten alloys. The emitter base 301 shown also includes surface features that increase the effective surface area base, such as grooves in which the filaments may be guided, thus enabling heat transfer away from the emitter base 301 by conduction and radiation. For carbon-based heat sources, upon combustion, the flame and the hot air can be directed at the emitter base to transfer the heat to the base, which then radiates the heat out.

Referring back to FIG. 2, the heat directing system 212 will collimate the heat and filter visible light and/or other undesired spectra from the emissions. To collimate the heat, the system includes one or more elements, referred to in this document as a collimator, that are structured to reflect or direct radiation and focus the heat as a beam toward the target. The reflecting elements may include reflectors of various geometries such as ellipsoidal, paraboloid, parabolic and/or flat. For example, in the heat generation subsystem 211 of FIG. 3, a parabolic reflector 303 serves as a collimator. The parabolic reflector 303 is supported and separated from the emitter base by one or more supporting rods 305. The heat source 302 generates heat, and the emitter base 301 directs the heat toward a concave, reflecting surface of the parabolic reflector 303. The heat reflects off of the concave surface of the parabolic reflector 303 and is focused into a heat beam 310 in a direction toward the target. The heat beam 310 is a collimated column of heat that has a higher intensity than would occur if the heat were allowed to diffuse immediately upon emission, without collimation. Optionally, the directing elements also may include lenses such as converging, diverging and Fresnel lenses. The level of collimation can also be adjusted to adjust the beam divergence by changing the distance between the emitter and the lenses.

The heat power control system 313 includes a processor, along with a memory containing programming instructions that will cause the processor to modulate the current passing through the resistive heating elements such that the system can achieve a desired emitter temperature. These elements of the heat power control system may be within the heating unit, or in an external server that is in communication with the heating unit via a communication portal 204 of the heating unit. The heat power control system 313 also may include a high temperature thermocouple or other temperature sensor that measures the temperature of the emitter, which the control system 313 can use to determine whether and when the desired temperature has been reached in the target area. Power control strategies can be achieved via the switching of AC/DC power. modulating the voltage delivered to the heat generation system 211, or other methods. The power provided to the heat generation system 211 also can be controlled with the help of a proportional-integral-derivative (P-I-D) control algorithm, such as those that are well-known at the time of this writing.

The perception subsystem 202 will include one or more sensors that collect data about a scene in the heating unit's environment, along with a processor and programming instructions that are configured to cause the processor to process data collected by the sensors and detect people and/or objects in the environment. Example sensors include an RGB camera, an infrared camera, a passive infrared detector array, time-of-flight sensors or other information. The sensors may interface with a vision system 251 component of the compute subsystem 205, which will be described below. Other sensors may include radar or other sonic sensors, a LiDAR system, or similar sensors that can detect objects in an environment, as well as Bluetooth or Wi-Fi sensors combined with triangulation systems that can identify the location of another device that is in a communication range of the sensors.

The system may include one or more motors 203 and mechanical components that enable the heating unit to move the heating subsystem 201 and thus direct the beam of heat toward the target. These may include rotational or translational joints about which the heating subassembly, comprising the emitter base 301 and parabolic reflector 303, may pan/tilt/roll or a combination thereof. These also may include a base with wheels and/or rollers and a drive system that causes the wheels or rollers to turn and move the heating unit 211 to a location.

As described above, the sensors of the perception system 202 may provide data to the vison system 251 of the computing subsystem 205. The vision system 251 will apply one or more perception algorithms to process the sensor data and identify people or objects to which heat may be directed. The vision system 251 may include programming for any suitable perception algorithms, such as knowledge-based algorithms, feature-based algorithms or template matching algorithms such as Eigenface-based algorithms and Fischer's discriminant. The system may use known processes such as multi-person detection and tracking, skeleton tracking, and semantic segmentation to identify a person and/or areas of interest to be heated. The system also may process the data using a trained model (such as a naïve Bayes classifier) or a neural network that classifies objects in the sensor data a people, other objects, and the like.

The perception subsystem 202 may use a target prioritization system 252 to classify and distinguish people and/or objects from each other so that if multiple people or objects are present in a scene (as with person 12 and person 14 in FIG. 1), the system selects one person or object as the target to which it will direct heat.

The computing subsystem 205 also will include a motor control system 253 with programming instructions that are configured to cause the processor to generate certain commands to actuate, deactivate and otherwise control operation of the motor(s) 203 and direct the collimated beam toward the target.

The computing subsystem 205 also will include a heat level control system 254 with programming instructions that are configured to cause the processor to generate certain signals that increase or decrease the intensity of the heat beam that is directed toward the target, thus conditioning (i.e., moderating by increasing or decreasing) the temperature of the target area. Control methods that can be used include pulse width modulation of a DC control signal, AC phase angle control or AC zero voltage switching. Optionally, the computing subsystem may include a personal comfort setting module 255. For example, the system may include or have access to a data store (such as a memory on server 18 of FIG. 1) that contains profile data for various individuals. The profile data may include information such as preferred temperatures, and previous and/or common patterns of the individual's movement in the environment. When the vision system 251 recognizes an individual who is associated with a profile that is in the data store, the personal comfort setting module 255 may use that person's profile data to control the temperature and direction of heat. For example, the system may generate heat to yield a temperature that corresponds to a preferred temperature stored in the profile. The system also may identify typical times of day that the user moves from point A to point B, and it may anticipate such movements on future days by moving the target area for its heat beam from point A to point B within a threshold period of time (such as one minute) before the time that the person's profile indicates that the person is likely to move from point A to point B. The personal comfort setting module 255 also may include or have access to a thermal model of the target area, environmental parameters, and thermal needs (such as predetermined parameters) to determine a level and duration of the heat that will be applied to an area.

The enclosure 206 may house some or all of the subsystems described above. Multiple heating subsystems within the same enclosure can be used to heat multiple targets from the same device. Depending on the number of heating subsystems included and the use case, different form factors for the enclosure can be adopted. They can be broadly categorized as single beam systems and multiple beam systems. Each of these categories may be subdivided into those with a stationary beam or beams (in which beam direction is stationary and adjusted manually) or those with a tracking beam or beam (in which the beam follows or advances in front of the target).

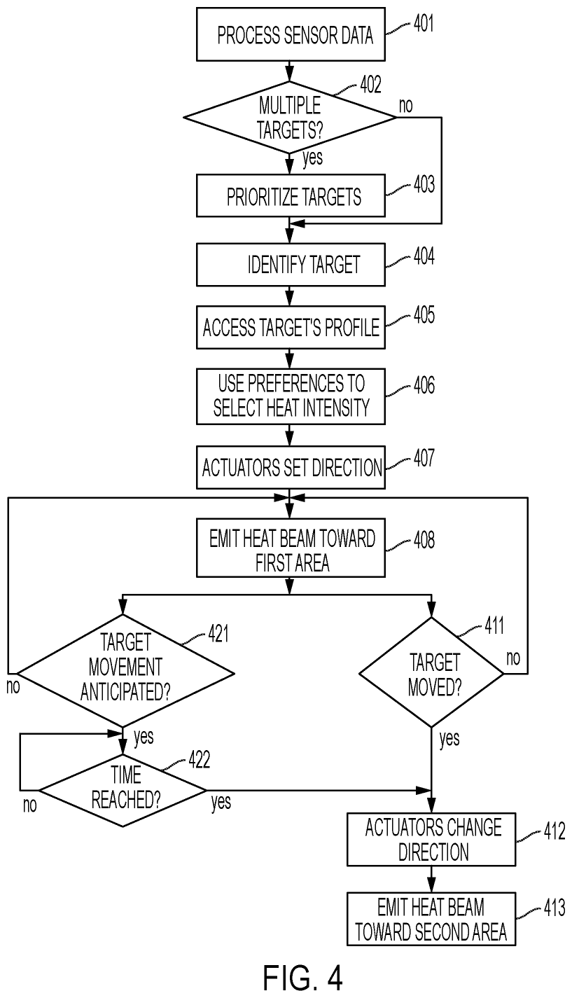

FIG. 4 is a flow diagram illustrating various elements of a method of operating a personalized heating system. At 401 one or more sensors will capture sensor data about an environment that includes a target. As described above in the context of perception system 202, the sensors will be elements of a perception system such as cameras, sonic sensors, LiDAR systems, or the like. At 404 the system will process the sensor data to identify a target toward which the system will direct heat. If multiple potential targets are identified (402: YES), then the system at 403 the system may use the target prioritization system to rank or classify the targets. For example, the system may rank the potential targets by position, size, or profile data, and then select the highest ranking potential target at 404. Alternatively, or in addition, the system may classify the targets (such as person, chair, dog, etc.) and then select the potential target at 404 that fits within a specified class (such as person). Optionally, the system may combine these steps by classifying the potential targets, ranking the potential targets of the specified class, and then selecting the highest ranking potential target that is also within the specified class. Other methods of prioritizing targets are possible.

Optionally, after identifying the target, at 405 the system may access a stored profile for the target, as stored in a data store. For example, if the system recognizes the target as one for which a profile is stored, the system may access that profile. Alternatively, the system may obtain an identifier from the target, either by input from the target or the target's proxy or by communicating with an electronic device that the target is using, and then use that identifier to lookup the target's profile in the data store. Once the system has accessed the target's profile, at 406 the system may use the target's preferences to set a heat intensity that the system will use to direct heat toward the target. If no preference information is available, then the system may set the heat intensity to a default level, or else to a level that is based on other factors.

At 407 the system's actuators will move the heat-emitting elements of the system to a position at which they will emit a heat beam toward a target area that includes the target. At 408 the system will emit the heat beam toward that target area at the intensity level that was set as described above.

In some embodiments, the sensors of the system may determine that the target moved to a second area (411: YES). If this happens, at 412 the actuators will set a new direction fort the heat by causing one or more motors of the system to move the heat-emitting elements of the system to a position at which the heat beam will be directed toward the second area. At 413, after the actuators have completed such movement, the system will emit a heat beam toward the second area.

In some embodiments, if the system had access to a profile for the target at 405, the system may use the profile to determine, from a pattern of movement in the profile, an anticipated time at which the target person is expected to move to a second target area. If this happens (421: YES), then at or within a threshold time period before the anticipated time (422: YES) the system may cause the one or more motors to set the direction of heat emitted by the heat source toward the second target area (step 412) direct the heat beam toward the second area (step 413). Until that happens (422: NO), the system will continue directing the heat beam toward the first area.

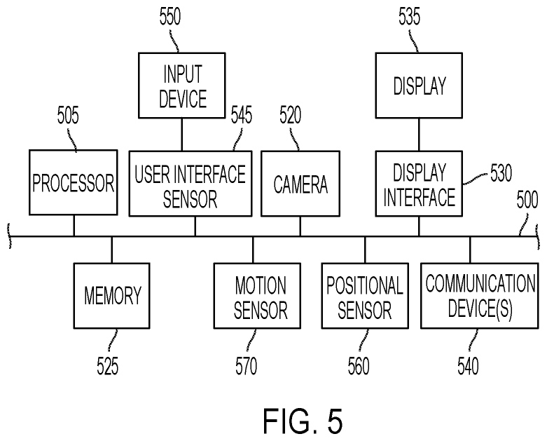

FIG. 5 depicts an example of internal hardware that may be included in any of the electronic components of the system, such as the computing device in the heating unit or in the remote server. An electrical bus 500 serves as an information highway interconnecting the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 525. A memory device may include a single device or a collection of devices across which data and/or instructions are stored.

An optional display interface 530 may permit information from the bus 500 to be displayed on a display device 535 in visual, graphic or alphanumeric format. An audio interface and audio output (such as a speaker) also may be provided. Communication with external devices may occur using various communication devices 540 such as a wireless antenna, a radio frequency identification (RFID) tag and/or short-range or near-field communication transceiver, each of which may optionally communicatively connect with other components of the device via one or more communication systems. The communication device 540 may be configured to be communicatively connected to a communications network, such as the Internet, a local area network or a cellular telephone data network.

The hardware may also include a user interface sensor 545 that allows for receipt of data from input devices 550 such as a keyboard, a mouse, a joystick, a touchscreen, a touch pad, a remote control, a pointing device and/or microphone. Digital image frames also may be received from a camera 520 that can capture video and/or still images. The system also may include a positional sensor 560 and/or motion sensor 570 to detect position and movement of the device. Examples of motion sensors 570 include gyroscopes or accelerometers. Examples of positional sensors 560 include a global positioning system (GPS) sensor device that receives positional data from an external GPS network.

Terminology that is relevant to this disclosure includes:

A “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of computing devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement, such as smart thermostats, refrigerators, connected light bulbs and other devices. In a client-server arrangement, the client device and the server are computing devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 4.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The network may include or is configured to include any now or hereafter known communication networks such as, without limitation, a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MTConnect communication network, a cellular network a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. As such, the communication network may be configured to implement wireless or wired communication through cellular networks, WiFi, BlueTooth, Zigbee, RFID, BlueTooth low energy, NFC, IEEE 802.11, IEEE 802.15, IEEE 802.16, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MTConnect, CoAP, REST API, XMPP, or another suitable wired and/or wireless communication method. The network may include one or more switches and/or routers, including wireless routers that connect the wireless communication channels with other wired networks (e.g., the Internet). The data communicated in the network may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, MTConnect protocol, or any other protocol.

The features and functions described above, as well as alternatives, may be combined into many other different systems or applications. Various alternatives, modifications, variations or improvements may be made by those skilled in the art, each of which is also intended to be encompassed by the disclosed embodiments.

1. A heating system, comprising:
a heat source;
one or more actuators configured to set a direction of heat emitted by the heat source;
one or more sensors that capture sensor data about an environment;
a processor; and
programming instructions that are configured to, when executed, cause the processor to:
process the sensor data and identify a target person in the environment and a first target area for the target person,
cause the one or more actuators to set a direction of heat emitted by the heat source toward the first target area, and
cause the heat source to generate a beam of heat, thereby directing heat toward the first target area.

2. The heating system of claim 1, further comprising additional programming instructions that are configured to cause the processor to:
process the sensor data and determine whether the target person is moving or has moved in the environment;
in response to determining that the target person is moving or has moved:
identify a second target area, and
cause the one or more actuators to move the heat source to direct the beam of heat toward the second target area.

3. The heating system of claim 1, further comprising additional programming instructions that are configured to cause the processor to:
access, from a data store, a profile for the target person;
use preference data in the profile to determine an intensity level; and
when causing the heat source to generate the beam of heat, cause the heat source to generate the beam of heat at the determined intensity level.

4. The heating system of claim 1, further comprising additional programming instructions that are configured to cause the processor to:
access, from a data store, a profile for the target person;
use the profile to determine, from a pattern of movement in the profile, an anticipated time at which the target person is expected to move to a second target area; and
at or within a threshold time period before the anticipated time, cause the one or more actuators to move the heat source to direct the beam of heat toward the second target area.

5. The heating system of claim 1, wherein:
the heat source is housed within or on top of an emitter base;
the emitter base comprises a plurality of grooves; and
one or more filaments comprising ductile material are wound around the emitter base within the grooves.

6. The heating system of claim 1, further comprising a collimator, and wherein:
the heat source is housed within an emitter base that is positioned to emit the heat toward the collimator; and
the collimator is configured to focus the heat into the beam of heat.

7. The heating system of claim 6, wherein:
the collimator comprises a parabolic reflector; and
the emitter base that is positioned to emit heat toward a concave surface of the parabolic reflector.

8. The heating system of claim 7, further comprising a lens positioned to receive and focus heat reflected off of the concave surface of the parabolic reflector.

9. The heating system of claim 1, wherein:
the heat source is housed within an emitter base;
the emitter base comprises a surface having a plurality of surface features that increase the effective surface area of the surface relative to a smooth surface.

10. A heating system, comprising:
a heat source;
one or more actuators configured to set a direction of heat emitted by the heat source;
one or more sensors that capture sensor data about an environment;
a collimator;
an emitter base that houses the heat source and that is positioned to emit heat generated by the heat source toward the collimator so that the collimator will focus the heat into a beam of heat;
a processor; and
programming instructions that are configured to, when executed, cause the processor to:
process the sensor data and identify a target person in the environment and a first target area for the target person,
cause the one or more actuators to set a direction of the beam of heat toward the first target area, and
cause the heat source to generate the beam of heat, thereby directing the heat toward the first target area.

11. The heating system of claim 10, wherein:
the collimator comprises a parabolic reflector; and
the emitter base is positioned to emit the heat toward a concave surface of the parabolic reflector.

12. The heating system of claim 11, further comprising a lens positioned to receive and focus heat reflected off of the concave surface of the parabolic reflector.

13. The heating system of claim 10, wherein:
the emitter base comprises a surface having plurality of surface features that increase the effective surface area of the surface relative to a smooth surface.

14. The heating system of claim 10, further comprising an enclosure that contains the heat source and one or more additional heating subsystems.

15. A method of providing personalized heating to a target, the method comprising, by a processor:
receiving sensor data from one or more sensors;
processing the sensor data to identify a target person in an environment and a first target area for the target person;
causing one or more actuators to set a direction of heat emitted by a moveable heat source toward the first target area;
causing the heat source to generate heat;
collimating the heat into a beam of heat; and
directing the beam of heat toward the first target area.

16. The method of claim 15 further comprising, by the processor:
processing the sensor data to determine whether the target person is moving or has moved in the environment;
in response to determining that the target person is moving or has moved:
identifying a second target area, and
causing the one or more actuators to move the heat source to direct the beam of heat toward the second target area.

17. The method of claim 15 further comprising, by the processor:
accessing, from a data store, a profile for the target person;
using preference data in the profile to determine an intensity level; and
when causing the heat source to generate the heat, causing the heat source to generate the heat at the determined intensity level.

18. The method of claim 15 further comprising, by the processor:
accessing, from a data store, a profile for the target person;
using the profile to determine, from a pattern of movement in the profile, an anticipated time at which the target person is expected to move to a second target area; and
at or within a threshold time period before the anticipated time, causing the one or more actuators to move the heat source to direct the beam of heat toward the second target area.

19. The method of claim 15 further comprising, by the processor, in response to identifying multiple potential targets:
using a target prioritization system to rank the potential targets, and
selecting, as the target, the potential target having the highest rank.

20. The method of claim 15 further comprising, by the processor, in response to identifying multiple potential targets:
using a target prioritization system to classify the potential targets, and
selecting, as the target, the potential target having a specified class.
